(19) United States
(12) Patent Application Publication
(10) Pub. No.: US 2008/0244915 A1
(43) Pub. Date: Oct. 9, 2008

(54) Carving and light utility chain saw guide bar

(76) Inventor: Brain J. Ruth, Lehighton, PA (US)

Correspondence Address: SANFORD J. PILTCH, ESQ., 1132 HAMILTON STREET, SUITE 201, ALLENTOWN, PA, 18101, US

(21) Appl. No.: 11/784,420

(22) Filed: Apr. 6, 2007

(51) Int. Cl. B23D 57/02

(52) U.S. Cl. 30/387

(57) ABSTRACT

A lightweight chainsaw guide bar capable of carving and shaping wood and other solid materials with the ability to cut in curvilinear fashion in a tighter radius due to hollowing out or eliminating portions of the guide bar.

### BACKGROUND OF THE INVENTION

This invention relates to a guide bar for a chainsaw for guiding a continuous loop of saw chain around the working end tip and back to the power unit to which it is mounted. More particularly, the invention relates to a chainsaw guide bar that is greatly reduced in weight and structure than that of commercially available guide bars. However, and most importantly, the invention relates to a guide bar that is to be used for, and excels in, non-conventional mannered purposes, such as carving and shaping, with great ease and efficiency.

Chainsaws have been used in the logging, lumber and wood processing industry for nearly 100 years. Chainsaws and their component parts have been designed to withstand the rigors of this industry. Resulting guide bar design has remained relatively bulky and heavy in nature to meet industry demands.

Since a chainsaw guide bar can comprise up to 25% of a chainsaw's weight, a reduction in guide bar weight can significantly reduce the overall weight of a chainsaw. Furthermore, since the guide bar extends some distance forward of the users hands, its weight is leveraged and over time produces a very tiring effect on the user. This tiring effect can increase the risk of accident and injury as well as reduce the amount of time a user can operate a saw.

In the past, several methods have been devised to lighten the chainsaw bar. All of them have utilized either a method of replacing areas of the solid body of the bar with inserts of a lighter weight material or by leaving hollow areas in the center plate or plane of a laminated bar or by making the width of the bar thinner or a combination of these methods. Chainsaw guide bars to this point in time have been fully planar along their working end, without any hollows or holes of any significant size.

One previously granted patent, U.S. Pat. No. 2,660,204 [Rosenboom] describes an adjustable chain saw bar that has a chain guiding track that is adjustable in width so that the working clearance can be easily maintained, cuts straight, and adds strength and rigidity to the bar. The drawbacks of this design are that it will not cut in a curved fashion. Further this type of chainsaw bar is not lightweight. Additionally, this guide bar cannot be used for non-conventional purposes, such as carving and shaping.

Another prior patent, U.S. Pat. No. 4,138,813 [Harada] describes a chain saw guide bar which is light weight and includes a pair of plates of small thickness each formed on the surface of the guide bar and forms a groove on each of their surfaces to increase the rigidity and strength of the guide bar. The drawbacks of this design are that it is a fully planar design, with no hollows or holes to lighten the chainsaw bar. Additionally, it is not capable of sculpting, carving, shaping or executing precise cutting of a small amount of wood or similar material such as ice, stone, composite material, bone, and food stuffs.

Another earlier apparatus is described in U.S. Pat. No. 4,654,972 [Sellmaier] as an elongate chain support blade that provides clearance between respective runs of the chain and longitudinal edges of the blade, thereby reducing friction and reducing oil usage. The drawbacks of this design are that it is not lightweight; and it does not contain any hollows or holes to lighten the chainsaw. Additionally, it contains a spur wheel and guide wheel at the front end of the blade. Moreover, it is designed for the purpose of cutting trees and not capable of sculpting, carving, shaping or executing precise cutting of a small amount of material.

Still several earlier devices describe chain saw guides which have cut-out sections filled with resin or some other non-metallic material to reduce the weight of the guide bar while still retaining rigidity. U.S. Pat. No. 4,837,934 [Krohn] describes a chain saw bar that defines an elongate open area within which is formed an insert member of a lightweight, non-metallic material. U.S. Pat. No. 5,014,435 [Date] describes a chain saw guide with an inner plate and a pair of outer plates fixed to the two flat sides of the inner plate. The inner and outer plates have holes that are filled with resin in order to lighten the weight of the saw but still maintain the rigidity. U.S. Pat. No. 5,025,561 [Sugihara] describes a guide bar for a chain saw with holes in the main body which contains a resin filler which would be shock-absorbing, weight-lightening in order to give rigidity to the guide bar and also cut down on vibrations. Finally, U.S. Pat. No. 5,035,058 [Date] describes a chain saw guide bar having oppositely located flat sides, with a plurality of recesses on each side and some recesses being filled with a lightweight material, while others function as oil reservoirs and oil passages between the guide grooves of the bar.

The drawbacks to these designs are the inserts or holes are filled with a non-metallic or resin material which are used solely for the purpose of stiffening and adding rigidity to the bar. Additionally, it is designed for users in the logging industry, so they are much larger than the present invention. Moreover, the guide bar is planar, and used for cutting in a straight line, and not capable of allowing for carving and sculpting small amounts of material.

Still other prior patents describe planar guide bars that contain longitudinal extending cutouts that are filled with a lighter weight material. U.S. Pat. No. 5,271,157 [Wieninger] describes a guide bar with two steel side parts and a center part connected to the side parts. Additionally, the guide bar contains cut outs in the side parts and in the center part of the guide bar extending in the longitudinal direction which are filled with a lighter material. U.S. Pat. No. 5,842,279 [Andress] describes a guide bar with a single steel plate, and a cut out extending over a portion of the longitudinal extension and over a portion of the height filled in with a casting material having a smaller density than the steel plate. The casting material is used for the purpose of adding a high torsional stiffness and lightening the weight of the guide bar. U.S. Pat. No. 6,427,342 [Breitbarth] describes a guide bar for a chain saw having an elongate planar body with an opening extending therethrough, and an elongate insert made from a lighter weight material to fit within the opening in the main body.

The drawbacks of these designs are that the guide bars have a great length and are more difficult to handle. Additionally, the guide bars are all planar. They all contain at least one main elongated cutout in the center of the guide bar, which then needs to be filled with a lighter weight material in order to add rigidity to the guide bar, so that it will cut steadily in a straight line. They are not capable of cutting in a curved manner. Moreover, these devices are made for larger scale industrial use. Additionally, it would not be capable of carving or sculpting small amounts of material.

In recent years, the appearance of alternate cutting applications has increased, due to the chainsaws continuing decrease in weight These alternate uses require more precise cutting of less material than traditionally required by a chain saw, thus, the guide bar strength is less of an important factor of its usefulness as is its reduction in weight. These alternate uses also require the freeform shaping of wood or similar material whereas the new bar designs ability to make curved cuts rather than straight cuts would greatly increase its usefulness as well as its maneuverability and ease of manipulation. These alternate uses include but are not limited to ornamental and architectural shaping as well as for furniture and sign making, timber frame and log construction applications and chain saw art and crafts.

Operating a chainsaw, for a purpose such as carving a statue or figure from wood is an extremely physically tiresome task. Not only does the chainsaw need to be supported in an infinite number of physical positions, but also constantly and forcefully manipulated in both random and repetitious manners. Since there is such a great deal of guide bar manipulation in the process of shaping wood or material, heavy guide bars are extremely cumbersome and wearing on the user, increasing risk of accident or injury and decreasing the carvers quality of workmanship as well as the time a carver can safely operate the chainsaw.

The carving and shaping of wood or other material often requires the shaping of concave and convex surfaces. Modern, standard chainsaw guide bars are designed to cut in a straight line. Obtaining such shapes with a guide bar that cuts straight is a tedious process. Narrow tipped guide bars are available and marketed to the carving industry, however, they are fully planar in design, restrictive to making radius and curved cuts and heavy, as they are constructed in the same manner as a guide bar designed for felling trees and sectioning logs.

### SUMMARY OF THE INVENTION

The substance of this invention is to provide a chainsaw guide bar, generally under twenty inches in length, that meets the needs of a person using a chainsaw in order to sculpt, carve, shape, or execute precise cutting of a small amount of wood or similar material such as ice, stone, composite material, bone and food stuffs.

The new guide bar will be up to 50% lighter than presently manufactured guide bars of the same length. This significant reduction in weight benefits the user in multiple ways. By reducing the overall weight of the tool, you will increase the amount of time a user can safely operate a chainsaw. Secondly, because the guide bar protrudes some distance forward of a chainsaw users hands, its weight is leveraged, moreover, since the guide bar is in constant motion when shaping with a chainsaw. The process of repeatedly stopping and redirecting the guide bar and chain is very wearing on the user due to the inertia of a heavy bar. A lighter weight guide bar would have much less inertia and be much easier to manipulate increasing operator workmanship, effectiveness and lengthening the users' safe operating time.

The new guide bars will be able to execute the smallest radius cuts of any chainsaw guide bar. In the process of carving and shaping with a chainsaw, the ability to cut in curvilinear fashion is of great value. It has been the object of all prior art to cut in a straight line, whereas the new guide bars will be able to execute a three-inch radius curved cut through several inches of wood or similar material. The ability to make such cuts would significantly increase a chainsaw carver's efficiency and be of great value.

The new guide bar will easily be able to smooth large areas of material of a slight concave or convex shape by gliding the chain saw guide bar in a side to side motion. Whereas present guide bars have nearly straight guide rail edges, the new guide bars can have a convex guide rail edge to conform to concave shapes and/or a section of free chain edge to conform to convex shapes as opposed to present guide bars that will only conform to flat or nearly flat surfaces.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a side view of the guide bar with a solid body and sprocket tip showing guide rail edges top.

FIG. 1A is a cross-sectional view taken along Line A-A of FIG. 1 showing guide rail edges top and bottom and hollow ground nature of the longitudinal section of the guide bar.

FIG. 2 is a side view of the guide bar and a weight-relieving aperture therethrough to lighten the guide bar and reduce the overall weight of the saw.

FIG. 2A is a cross-sectional view taken along Line A-A of FIG. 2 showing the inner edges of the weight relieving aperture as being tapered to a blunt rounded edge to facilitate a smooth passage over material being cut.

FIG. 2B is a cross-sectional view taken along Line B-B of FIG. 2 showing the longitudinal guide rail set parallel with the top longitudinal guide rail at a minimum distance apart with the bottom portion of the bar concavely shaped.

FIG. 3 is a side view of the guide bar showing a plurality of weight relieving apertures that can be shaped in any manner of ways to serve for functional and/or aesthetic purposes.

FIG. 3A is a cross-sectional view taken along Line A-A of FIG. 3 showing guide rail edges top and bottom and hollow ground nature of the longitudinal section of the guide bar.

FIG. 3B is a cross-sectional view taken along Line B-B of FIG. 3 showing the inner edges of the weight-relieving aperture as being tapered to a blunt rounded edge to facilitate a smooth passage over material being cut.

FIG. 4 is a side view showing the guide bar possessing a standard mounting end but only one longitudinal guide rail edge for the length of the bar from mounting end to the tip.

FIG. 4A is a cross-sectional view taken along Line A-A of FIG. 4 showing guide rail at bottom and fluid transfer tube on top.

### DETAILED DESCRIPTION OF THE INVENTION

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

Referring now to the drawings in detail, where like numerals refer to like parts or elements, there is shown the new guide bar designs of the present invention. The new guide bar design is not so much a change in present guide bar manufacturing processes, but a change in structure, shape, weight, and use. The new guide bars may be solid, laminate, or composite in material. They may have hardened, alloy, or sprocket tips and may or may not contain adjusting mechanisms to tension the saw chain and may or may not have fluid transfer systems to service the guide bar and saw chain.

Nearly all presently available guide bar design incorporates a fully planar design. The structural design maintains the guide bar in a substantially rigid configuration such that the guide bar remains in a single plane regardless of varying external or edge dimensions. The new guide bar of the present invention has been altered to enhance both the cutting and carving ability by altering its dimensions and its structural configuration. This will either permit flexure of the body of the guide bar by a number of different means such that the guide bar can flex away from the substantially rigid single planar configuration or the capacity of the guide bar to permit the saw chain to vary from its restricted path for enhanced carving and reduced radial cutting capabilities. Each of the following embodiments of various constructions of guide bars have similar nominal dimensions: eight inches to twenty-two inches in overall length and three to four inches in overall height. Variations of these dimensions will be discussed below, as required.

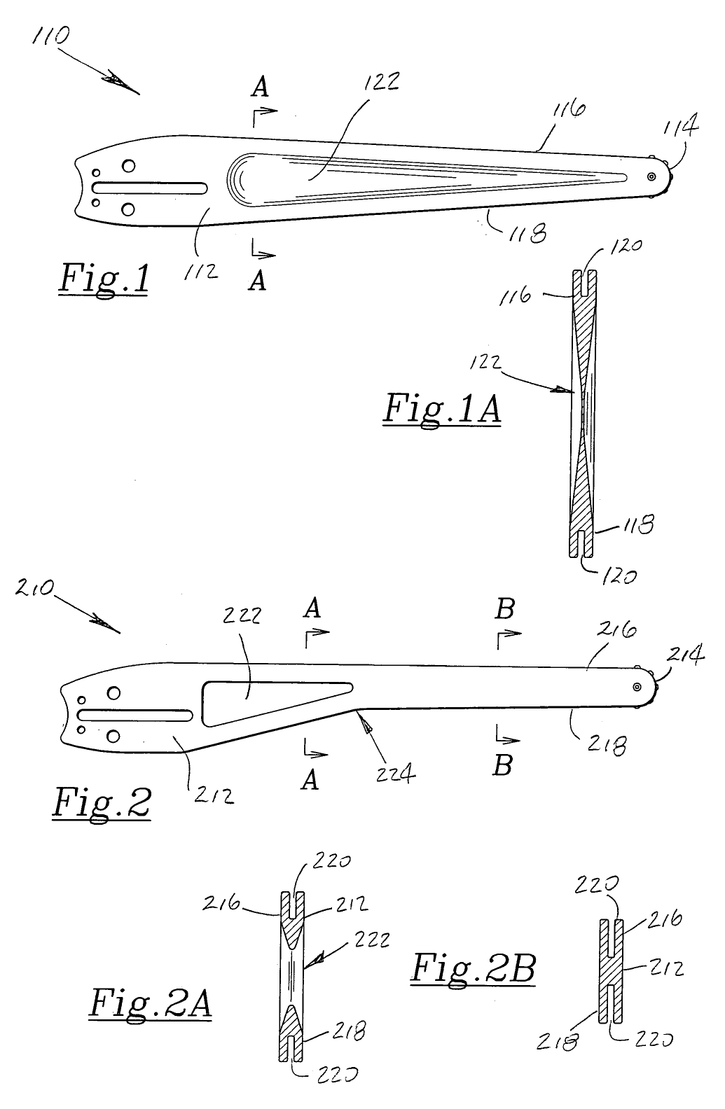

In a first embodiment of the invention, the planar surfaces of the new guide bar 110 have been hollow ground to both lighten the bar and to facilitate the user's execution of a decreased radius curved cut, enhancing the new guide bars carving ability. This embodiment provides the greatest structural strength and guide bar rigidity. The guide bar 110, as shown in FIG. 1, is one having a solid elongate body 112 and a distal end sprocket tip 114. The body 112 encompasses the length of the guide bar 110 including a top longitudinal guide rail 116 and a bottom longitudinal guide rail 118 extending outward to the sprocket tip 114. FIG. 1A displays a cross-section of the guide bar 110 showing the top and bottom guide rails 116, 118 and the extent of the hollow ground portion 122 of the elongate longitudinal section of the guide bar 110. The top longitudinal guide rail edge 116 and bottom longitudinal guide rail edge 118 each have a guide rail slot 120, which allows the saw chain to fit onto and ride within and along the guide rail slot 120. The hollow ground portion 122 permits the guide bar to conform around much tighter radius cuts for carving and finishing work pieces. The hollow ground portion 122 tapers toward the tip 114, as does the overall height dimension of the guide bar 110.

In a second embodiment shown in FIG. 2, the guide bar 210 has a weight-relieving aperture 222 therethrough to lighten the guide bar and reduce the overall weight of the saw. The elongate body 212 encompasses the aperture 222 positioned towards the rear of the guide bar 210 and extends forward, after the aperture 222, in a reduced height of approximately two inches ending at the sprocket tip 214. FIG. 2A shows the proximal end of the guide bar 210 with its sidewalls tapering inward toward the weight relieving aperture 222, which taper terminates in a rounded joint as the two sidewalls merge in order to facilitate a smooth passage over the material being cut. The top longitudinal guide rail 216 and bottom longitudinal guide rail 218 each have a guide rail slot 220, which allows the saw chain to fit onto and ride along the guide rail slot 220. FIG. 2B shows the distal end of the elongate body 212 of the guide bar 210 with the top longitudinal guide rail 216 and the bottom longitudinal guide rail 218, both with the guide rail slot 220. The guide bar 210 has been dimensioned at its distal end to a minimum size of approximately two inches in height, commensurate with the size of the chain being utilized of either ¼ or ⅜ inches, to minimize the radius curvilinear cut achievable. To provide for enhanced carving and contouring of a work piece, the bottom portion 224 of the guide bar 210, where the proximal and distal portions are joined, has been shaped in a substantially concave configuration resulting in the saw chain being untensioned along that surface. Although there is a difference in the overall height dimensions of the proximal and distal portions of the guide bar 210, the top and bottom longitudinal guide rails 216, 218 continue to be in a parallel plan with each other, with the distance between them set at a minimum distance apart at the tip 214.

Cutting with a chainsaw fitted with the guide bar 210 of this embodiment and engaging the bottom or returning run of the saw chain into wood or similar material of the work piece in the area of the joint between the bottoms of the proximal and distal portions of the bottom guide rail 218, pressure will be exerted upon the saw chain by the work piece that will entrain the return run of saw chain into the guide rail slot 220 of the bottom guide rail 218 of the guide bar 210. This structural configuration will afford the smallest height profile possible for the guide bar 210 and saw chain and allow for the minimum radius curved cut achievable, for the preferred size of saw chain being utilized.

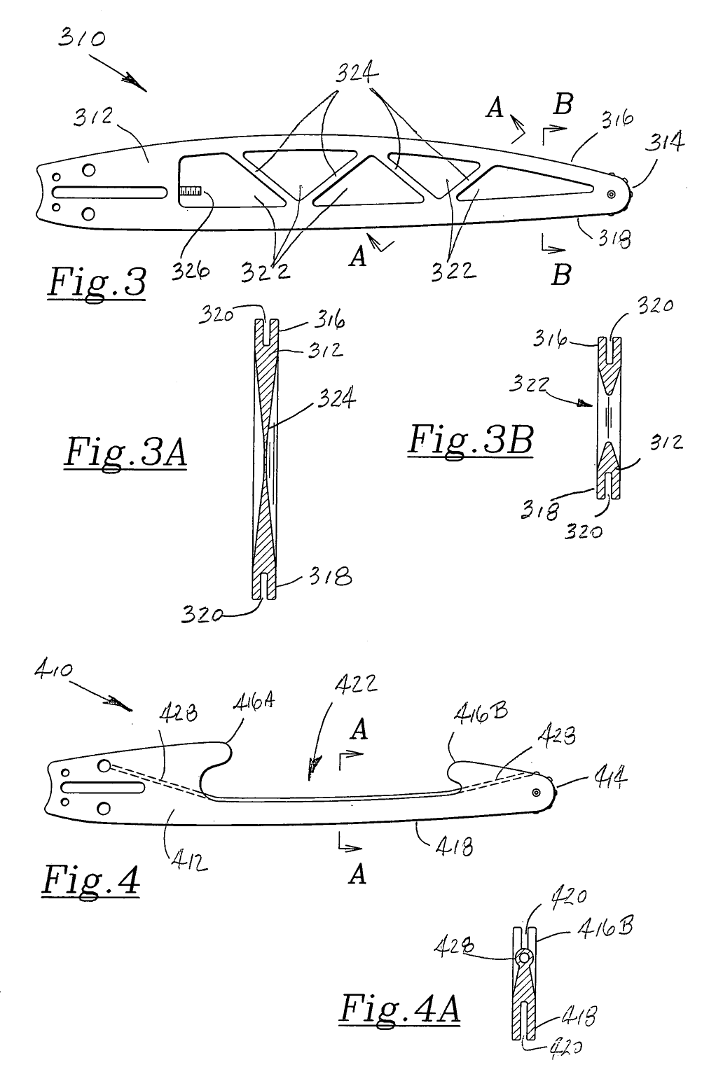

A third embodiment of the invention is shown in FIG. 3. The guide bar 310 is shown with a plurality of weight relieving apertures 322, which apertures can be shaped and dimensioned in any manner of ways to serve a number of functional and/or aesthetic purposes. The third embodiment of FIG. 3 displays an elongate body 312 that extends the length of the guide bar 310 and includes the plurality of apertures 322 terminating in the sprocket tip 314. Because of the small amount of material these guide bars 310 are designed to cut, generally less than six inches, depending on density, the guide bar 310 mounting or proximal end will rarely, if ever, be utilized. A hollow section within the frame of the guide bar 310 affords space for a mounting apparatus, such as a threaded rod 326, for connecting attachments for functional and/or aesthetic reasons, such as a light or nameplate. The threaded rod 326 is shown mounted inside one of the weight-relieving aperture 322, adjacent to the mounting end of the guide bar 310.

FIGS. 3A and 3B each display a different cross-section of the guide bar 310. FIG. 3A shows the sidewalls of the weight relieving apertures 322 tapering inward and terminating in a rounded joint as the two sidewalls merge in order to facilitate a smooth passage over the material being cut. Thus, each of the structural spokes 324 between the several weight-relieving apertures 322 are hollow ground and tapered to a rounded edge to facilitate a smooth passage over material being cut. The plurality of apertures 322 and their respective struts 324 serve to retain the top and a bottom longitudinal guide rails 316 and 318, respectively, in a parallel relationship as displayed in FIG. 3B. As in the previously described embodiments, the top guide rail 316 and bottom guide rail 318, each have a guide rail slot 320, which slot allows the chain to fit onto and ride along the guide rails of the bar 310.

The weight relieving apertures 322 serve not only to lighten the guide bar 310, but also to facilitate a reduced radius curved cut due to the special dimensioning and hollow grinding of the struts 324 such that the guide bar 310 will exhibit a slight flexure along the top guide rail 316 when stressed during cutting or carving. The top longitudinal guide rail 316 is partially convex in shape along its longitudinal dimension and is designed to flex across a small angle, laterally and out of parallel with the bottom guide rail 318, to further augment curvilinear cutting. When engaged in cutting an amount of material equal or less than one third the length of the guide bar 310 and cutting said material with the center section of the length of the bar 310 as the bar 310 is forced through the kerf of a curved cut. Longitudinal torque applied to the guide bar 310 by the operator in order to make a curved cut will bend the top longitudinal guide rail edge 316 away from its aligned parallelity in order to follow the bottom longitudinal guide rail edge 318 through a curvilinear kerf of a smaller radius than that of a guide bar that had a rigid top guide rail. The convex shape of the top rail 316 will also allow the user to conform a significant length of saw chain to a concave surface for the purpose of creating or smoothing a surface.

In the fourth embodiment of FIG. 4, the guide bar 410 possesses a standard mounting end and an elongate body 412, but only one complete longitudinal guide rail extending the length of the guide bar from mounting end to the sprocket tip 414. The reduced structure guide bar 410, in comparison to commercially available bars is greatly reduced in weight by the elimination of the greater portion of the top longitudinal guide rail 416, yet retains sufficient structural integrity commensurate to the light duty cutting and carving for which these guide bars are designed. Interposed between the proximal and distal portions of the top longitudinal guide rail 416A, 416B, respectively, is an extended aperture 422. The aperture 422 extends more than halfway into the guide bar 410 reducing the elongate body 412 to a reduced height along the bottom of the guide bar 410. The aperture 422 also spans a substantial longitudinal portion of the guide bar 410 such that the chain lubricating tube 428 must be relocated in the upper part of the elongate body 412 as more clearly shown in FIG. 4A. The chain lubricating tube 428 is mounted along the top longitudinal edge of the elongate body 412 and commuting with standard attachment holes to facilitate fluid transfer through guide bar 410 from the chainsaw power unit to service the guide bar 410 and saw chain. FIG. 4A, a cross-sectional view of FIG. 4 looking toward the tip 414, shows the elongate body 412 with the chain lubricating tube 428 located on top thereof. The top longitudinal guide rail portion 416B extends upward to grasp and guide the saw chain as the chain is recaptured after traversing over the aperture 422. As in the previous embodiments, the top longitudinal guide rail 416 and bottom longitudinal guide rail 418 each have a guide rail slot 420.

The usefulness of this embodiment is further enhanced over prior chainsaw devices by the unengaged run of saw chain traveling from the elongate body 412 to guide bar tip 414 over the extended aperture 422. This untensioned portion of saw chain will allow a user the ability to conform a significant section of unsupported saw chain to a convex shape for smoothing a work piece of virtually any shape in an efficient and effective manner. Further, the reduced height of the elongate body 412 of the guide bar 410 in the central portion of the guide bar 410 encompassed by the extended aperture 422 will enable a guide bar having this construction to achieve will afford a much smaller height profile for the guide bar 410 and saw chain and allow for the minimum radius curved cut achievable, for the preferred size of saw chain being utilized. Also, the absence of the top guide rail 416 across an extended portion of the guide bar 410 will also allow the user to conform a significant length of saw chain to a concave surface for the purpose of creating or smoothing a surface. The guide bar 410 and chain will also remain cooler than that of a conventional guide bar 410 due to a reduction in friction as the chain runs free over a significant portion of the elongate body 412 as there does not exist a top longitudinal guide rail over the extended aperture 422.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A guide bar for a chainsaw for light duty cutting, carving and shaping of a work piece, having an elongate body, an attaching end and working end with tip and opposing longitudinal guide rails to guide a saw chain around the working tip, said elongate body extending a distance within the range of 8 to 22 inches in overall length and an overall height within the range of 3 to 4 inches, and said elongate body having means for facilitating smaller radius kerf or curvilinear cuts for enhanced performance in conforming to convex and concave surfaces on the work piece.

2. The guide bar of claim 1, wherein the means for facilitating smaller radius kerf or curvilinear cuts for enhanced performance being one or more through holes formed in the elongate body of the guide bar.

3. The guide bar of claim 1, wherein the means for facilitating smaller radius kerf or curvilinear cuts for enhanced performance being a combination of one or more through holes and a narrowing of the guide bar at its working tip and along a substantial length of the elongate body.

4. The guide bar of claim 1, wherein the means for facilitating smaller radius kerf or curvilinear cuts for enhanced performance being hollow ground opposing side surfaces formed along a substantial length of the elongate body of the guide bar.

5. The guide bar of claim 1, wherein the means for facilitating smaller radius kerf or curvilinear cuts for enhanced performance being an elongate aperture formed within the elongate body of the guide bar such that only one longitudinal section of guide rail runs along the bottom of the guide bar with the opposing side open and without a guide rail so that the saw chain is without guide or support across the top side of the guide bar in the area of the elongate aperture.
